(19) United States
(12) Patent Application Publication
(10) Pub. No.: US 2014/0153184 A1
(43) Pub. Date: Jun. 5, 2014

(54) FAN CONTROL SYSTEM AND METHOD

(71) Applicant: HON HAI PRECISION INDUSTRY CO., LTD., New Taipei (TW)

(72) Inventors: YAO-TING CHANG, New Taipei (TW); CHAO-KE WEI, New Taipei (TW)

(73) Assignee: HON HAI PRECISION INDUSTRY CO., LTD., New Taipei (TW)

(21) Appl. No.: 13/859,744

(22) Filed: Apr. 10, 2013

(30) Foreign Application Priority Data
Dec. 4, 2012 (TW) 101145368

(51) Int. Cl. G06F 1/20

(52) U.S. Cl. CPC G06F 1/206
USPC 361/679.48

(57) ABSTRACT

A fan control system is executed by a microcomputer of a container data center. The center includes a number of server racks, and each server rack includes a number of fans. The system includes a control module and an adjusting module. The control module obtains a current power consumption of each server rack, determines the current power consumption of which server rack is greater than a standard value, and transmits an adjusting signal to each determined server rack. The adjusting module decreases a rotation speed of at least one fan of each determined server rack according to the adjusting signal until the current power consumption of each determined server rack is less than the standard value. A related fan control method is also provided.

### BACKGROUND

1. Technical Field

The present disclosure relates to fan control systems, and particularly to a fan control system applied in a container data center and a fan control method.

2. Description of Related Art

A container data center includes a container and a number of server racks, with standard power consumption, received in the container and holding many servers. When the power consumption of one rack exceeds the standard power consumption, power supply to the rack will be cut to prevent the servers from being overheat, thus the power supply structure would not be damaged by excessive current. However, if power is suddenly cut off, damage may occur to the servers in the rack.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of a container data center in accordance with an exemplary embodiment.

FIG. 2 is a flowchart of a fan control method in accordance with an exemplary embodiment.

### DETAILED DESCRIPTION

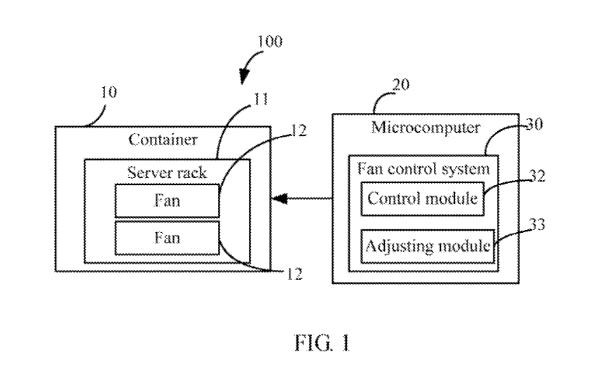

FIG. 1 is a container data center 100 of an exemplary embodiment. The container data center 100 includes a container 10, a microcomputer 20, and a fan control system 30. The container 10 includes a number of server racks 11. Each server rack 11 includes a number of fans 12 to cool the server rack 11. The fan control system 30 includes a number of modules which are executed by the microcomputer 20 to control operation of the fans 12 of each server rack 11. In the embodiment, one server rack 10 is employed to simply illustrate the present disclosure.

The fan control system 30 includes a control module 32 and an adjusting module 33. The control module 32 is operable to obtain a current power consumption of the server rack 11, and transmit an adjusting signal to the adjusting module 33 when the current power consumption is greater than a standard value. The adjusting module 33 is operable to decrease the rotation speed of at least one fan 12 of the server rack 11 according to the adjusting signal. After the adjusting module 33 decreases the rotation speed of at least one fan 12 of the server rack 11, the control module 32 is operable to again obtain the current power consumption of the server rack 10, and again transmits the adjusting signal to the adjusting module 33 when the current power consumption is still greater than the standard value. The adjusting module 33 is operable to again decrease the rotation speed of at least one fan 12 of the server rack 11. With such configuration, the adjusting module 33 is operable to repeat to decrease the rotation speed of at least one fan 12 of the server rack 11 until the current power consumption of the server rack 11 is less than the standard value.

In this embodiment, each time the adjusting module 33 receives the adjusting signal, the adjusting module 33 decreases the rotation speed of each fan 20 of the server rack 11 a first predetermined value. In an alternative embodiment, each time the adjusting module 33 receives the adjusting signal, the adjusting module 33 determines the current rotation speed of which fan 12 is greatest, and decreases the rotation speed of the determined fan 20 a second predetermined value. The first predetermined value and the second predetermined value can be the same or different.

In the embodiment, after the rotation speed of the fans 20 is decreased, the cooling effect may be poor. The control module 32 is further operable to generate a warning signal when the current power consumption of the server rack 11 is greater than the standard value. Thus, a manager can check the container data center 100.

With such configuration, when the current power consumption of the server rack 11 is greater than the standard value, the rotation speed of at least one fan 12 is decreased. When the rotation speed of at least one fan 12 is decreased, the power consumption of the fans 12 decreases, thus the power consumption of the server rack 11 decreases, which avoids sudden cutting off the power supplied to the container 10.

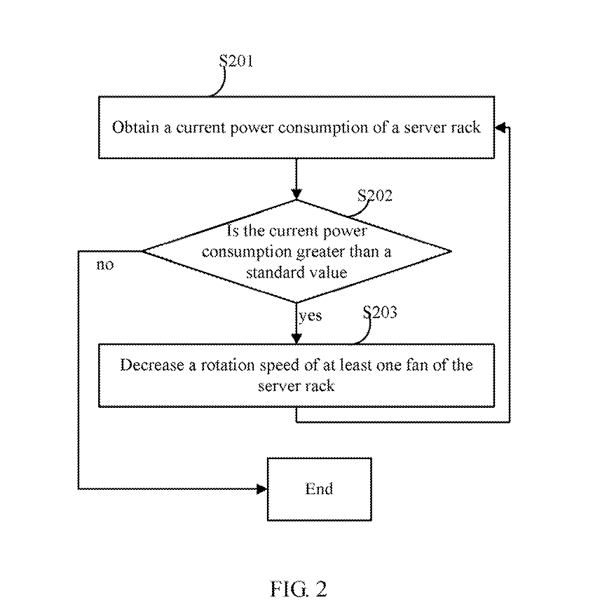

FIG. 2 is a flowchart of a fan control method in accordance with an exemplary embodiment.

In step S201, the control module 32 obtains current power consumption of the server rack 11.

In step S202, the control module 32 determines whether the current power consumption of the server rack 11 is greater than the standard value. If no, the procedure ends, otherwise the procedure goes to step S203.

In step S203, the control module 32 transmits the adjusting signal to the adjusting module 33, and the adjusting module 33 is operable to decrease the rotation speed of at least one fan 12 of the server rack 11 according to the adjusting signal. After executing step S203, the procedure returns to step S201.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A fan control system to be executed by a microcomputer of a container data center, the container data center comprising a plurality of server racks, each of the plurality of server racks comprising a plurality of fans, the fan control system comprising:
a control module to obtain a current power consumption of each of the plurality of server racks, determine the current power consumption of which of the plurality of server racks is greater than a standard value, and transmit an adjusting signal to each determined server rack; and
an adjusting module to decrease a rotation speed of at least one fan of each determined server rack according to the adjusting signal;
wherein, each time after the adjusting module decreases the rotation speed of at least one fan of each determined server rack, the control module again obtains the current power consumption of each of the plurality of server racks, determines the current power consumption of which of the plurality of server racks is greater than the standard value, and transmits the adjusting signal to each determined server rack.

2. The fan control system as described in claim 1, wherein the adjusting module to decrease a rotation speed of at least one fan of each determined server rack according to the adjusting signal comprises: the adjusting module is to decrease the rotation speed of each of the plurality of fans of each determined server rack a first preset value according to the adjusting signal.

3. The fan control system as described in claim 1, wherein the adjusting module to decrease a rotation speed of at least one fan of each determined server rack according to the adjusting signal comprises: the adjusting module is to determine the rotation speed of which of the plurality of fans of each determined server rack is greatest, and decrease the rotation speed of the determined fan a second preset value according to the adjusting signal.

4. The fan control system as described in claim 1, wherein the control module is further operable to generate a warning signal when the current power consumption of one of the plurality of server racks is greater than the standard value.

5. A fan control method to be executed by a microcomputer of a container data center, the container data center comprising a plurality of server racks, each of the plurality of server racks comprising a plurality of fans, the fan control method comprising:
obtaining a current power consumption of each of the plurality of server racks;
determining the current power consumption of which of the plurality of server racks is greater than a standard value, and transmitting an adjusting signal to each determined server rack; and
decreasing a rotation speed of at least one fan of each determined server rack according to the adjusting signal;
wherein, each time after decreasing the rotation speed of at least one fan of each determined server rack according to the adjusting signal, the current power consumption of each of the plurality of server racks is again obtained, and the rotation speed of at least one fan of each server rack which current power consumption is determined to be greater than the standard value is again decreased.

6. The fan control method as described in claim 5, wherein decreasing a rotation speed of at least one fan of each determined server rack according to the adjusting signal comprises: decreasing the rotation speed of each of the plurality of fans of each determined server rack a first preset value according to the adjusting signal.

7. The fan control method as described in claim 5, wherein decreasing a rotation speed of at least one fan of each determined server rack according to the adjusting signal comprises: determining the rotation speed of which of the plurality of fans of each determined server rack is greatest, and decreasing the rotation speed of the determined fan a second preset value according to the adjusting signal.

8. The fan control method as described in claim 5, further comprising:
generating a warning signal when the current power consumption of one of the plurality of server racks is greater than the standard value.
